(19) United States
(12) Patent Application Publication
(10) Pub. No.: US 2023/0012757 A1
(43) Pub. Date: Jan. 19, 2023

(54) DEVICE AND METHOD FOR CONTROLLING THE TEMPERATURE OF AN ENERGY STORE FOR ELECTRICAL ENERGY OF A MOTOR VEHICLE

(71) Applicant: MAN Truck & Bus SE, München (DE)

(72) Inventor: Reimar Braun, MÜNCHEN (DE)

(21) Appl. No.: 17/642,659

(22) PCT Filed: Sep. 4, 2020
(86) PCT No.: PCT/EP2020/074741

§ 371 Date: Sep. 6, 2022

(30) Foreign Application Priority Data
Sep. 12, 2019 (DE) 10 2019 006 487.9

(51) Int. Cl. H01M 10/63; H01M 10/615; H01M 10/625; H01M 10/6568; H01M 10/613; H01M 10/6556

(52) U.S. Cl. CPC H01M 10/63; H01M 10/615; H01M 10/625; H01M 10/6568; H01M 10/613; H01M 10/6556; H01M 2220/20; B60R 16/033

(57) ABSTRACT

The invention relates to a device (1) for controlling the temperature of an energy store (5) for electrical energy of a motor vehicle. The device comprises an energy store (5) for electrical energy and a fluid circuit (3) which can be and/or is thermally coupled to the energy store for controlling the temperature of the energy store, wherein a temperature control fluid can be supplied to and discharged from the energy store (5) through the fluid circuit. The fluid circuit (3) further comprises a pump device (10, 11) for transporting the temperature control fluid through the fluid circuit (3), a valve device (12), a cooling device (8) for cooling the temperature control fluid and a heating device (9) for heating the temperature control fluid. The fluid circuit (3) has a subcircuit (4) in which the heating device (9) is arranged, wherein the device (1) is designed to activate heating operation of the heating device (9) when the motor vehicle is parked and when a predetermined heating condition is satisfied. Fluidic coupling of the subcircuit to the fluid circuit and supply and discharge of temperature control fluid heated in the subcircuit to and from the energy store (5) for electrical energy can be controlled by means of the valve device (12). The invention further relates to a method for controlling the temperature of an energy store for electrical energy of a motor vehicle, and to a motor vehicle comprising an abovementioned device.

The present disclosure relates to a device and a method for controlling the temperature of an energy store for electrical energy of a motor vehicle. The present disclosure further relates to a motor vehicle, preferably a utility vehicle, having such a device.

Motor vehicles that are at least partially electrically driveable generally have an energy store for electrical energy, also referred to below as an electrical energy store for short. In this case, the electrical energy store can have a high-voltage (HV) motor vehicle battery. Various methods for not only cooling but also heating a high-voltage battery are known from practice. One possibility is heating water-glycol by means of heating/cooling fins in the base of the high-voltage battery. Other approaches include, for example, heating the cell or generating reactive power, for example via the arrester.

However, motor vehicles are often only actively in operation for a fraction of the time. Therefore, it is possible for the electrical energy store, in particular the individual battery cells, to cool down when the vehicle is parked. It is known that excessively high or excessively low temperatures have a disadvantageous effect on the service life, performance and functionality of such a battery. In particular, the problem arises that, below a critical minimum temperature, the batteries of the energy store are no longer able to provide enough power for starting operation when the vehicle is restarted. For example, if the high-voltage battery cools down excessively, only a small amount of energy or no energy at all from the cells can be provided by the high-voltage battery, in particular also for heating, since the current limits of the cells are dependent on the state of charge (SoC) and on the temperature. Known approaches for heating high-voltage batteries additionally have the disadvantage that they require a very large amount of energy for this purpose.

Therefore, one object of the present disclosure is to provide a device for controlling the temperature of an electrical energy store with which disadvantages of conventional technologies can be avoided. The object of the present disclosure is, in particular, to provide an approach for controlling the temperature of an energy store by means of which cooling down of the electrical energy store can be avoided even when the vehicle is parked and whereby heating of the electrical energy store in as energy-efficient a manner as possible is rendered possible even when the vehicle is parked.

These objects are achieved by a device and a method having the features of the independent claims. Advantageous embodiments and applications of the present disclosure are the subject matter of the dependent claims and will be explained in more detail in the following description, with reference being made to the figures in part.

According to a first general aspect of the present disclosure, a device for controlling the temperature of an energy store for electrical energy of a motor vehicle is provided. The motor vehicle can be an electrically driveable and/or driven motor vehicle. The device comprises an energy store for electrical energy, also referred to below as an electrical energy store or as an energy store for short.

The device further comprises a fluid circuit which can be and/or is thermally coupled to the energy store for controlling the temperature of the energy store, wherein a temperature control fluid can be supplied to and discharged from the energy store through the fluid circuit. In this case, the fluid circuit can comprise a pump device for transporting the temperature control fluid through the fluid circuit, a valve device, a cooling device for cooling the temperature control fluid and a heating device for heating the temperature control fluid. The fluid circuit further comprises a subcircuit in which the heating device is arranged. This subcircuit is also referred to below as the first subcircuit. Therefore, the fluid circuit can selectively serve as a cooling circuit and a heating circuit.

According to the present disclosure, the device is designed to activate heating operation of the heating device when the motor vehicle is parked and when a predetermined heating condition is satisfied, wherein fluidic coupling of the subcircuit to the fluid circuit and supply and discharge of temperature control fluid heated in the subcircuit to and from the energy store for electrical energy can be controlled by means of the valve device.

As a result, cooling down of the energy store when the motor vehicle is parked can also be prevented. Furthermore, particularly energy-efficient heating of the temperature control fluid and therefore energy-efficient heating of the energy store is possible since only a partial quantity of the temperature control fluid can be heated by means of the heating device arranged in the subcircuit, it then being possible to supply this partial quantity by means of the valve device in a targeted manner to the energy store for local heat output. Accordingly, thermal losses can be reduced. At the same time, cost-effective implementation of the device is possible since a heating circuit that is separate from the cooling circuit is not provided, but rather said heating circuit is integrated into the cooling circuit.

A parked vehicle is preferably intended to be understood to mean a parked state of the motor vehicle, in particular an inoperative state of the motor vehicle, for example when the motor vehicle is parked.

In this case, preferably only a partial quantity of the temperature control fluid is heated by the heating device during heating operation. According to a particularly preferred embodiment, the device is designed in this case to heat a partial quantity, preferably a predetermined partial quantity, of the temperature control fluid in the subcircuit using the heating device when heating operation is activated in a first step, wherein the subcircuit is fluidically separated from the rest of the fluid circuit and/or the energy store by means of the valve device. According to this embodiment, the device is further designed to fluidically connect the subcircuit to the energy store by means of the valve device and to pump the heated predetermined partial quantity to the energy store by means of the pump device in a second step.

In this case, a further, second subcircuit, in which the cooling device is arranged, can be fluidically separated from the rest of the fluid circuit, which comprises the first subcircuit and the portion containing the energy store, in the first step and/or in the second step. The predetermined partial quantity of temperature control fluid can be defined by the size and/or fluid receiving capacity of the first subcircuit and/or by the position of individual valves of the valve device for fluidically coupling the first subcircuit to the fluid circuit.

This renders possible particularly energy-efficient heating of the energy store since firstly it is possible to prevent the entire quantity of temperature control fluid in the fluid circuit from being heated during heating operation and energy being expended for this purpose. Thermal losses on account of the thermal capacity of the fluid circuit can therefore be reduced. This is particularly advantageous when a parked vehicle is not connected to an external power supply or charging station and the energy of the energy store is provided, for example, by the energy store itself or another vehicle battery. Accordingly, excessively rapid discharging of the energy store due to heating operation can be avoided owing to the lower energy consumption. Furthermore, a partial quantity of temperature control fluid can be heated more quickly than the total quantity, and therefore the heating process is quicker overall.

In one advantageous variant of this embodiment, the device can be designed to carry out several sequences for heating the energy store when heating operation is activated, wherein each sequence comprises the first step and the second step, preferably in such a way that sequential pulses of heated partial quantities of the temperature control fluid are pumped to the energy store, instead of a continuous flow of temperature control fluid. In other words, several sequences with heated temperature control fluid are pumped into the energy store in succession and/or in pulses. As a result, the required quantity of heated temperature control fluid can be defined more accurately and/or the required quantity of temperature control fluid needed can be reduced in order to protect the energy store from cooling down too much.

For example, the device can be designed to drive the valve device and the pump device in the second step in such a way that the heated predetermined partial quantity is pumped into the throughflow region of the energy store and remains there for a minimum time period by stopping the fluid flow. As a result, particularly efficient thermal coupling to the energy store is achieved since the majority of the heat of the heated temperature control fluid can be output to the energy store in a targeted manner and only a relatively small portion can be output to other line segments. Furthermore, sequential pumping operation consumes less energy than continuous operation of the temperature control fluid.

Furthermore, the energy store can be thermally coupled to the fluid circuit via a throughflow region formed in a wall region, preferably in a base plate, of the energy store. In this case, the predetermined partial quantity of temperature control fluid which is heated in the first step can optionally further correspond to a receiving capacity of the throughflow region of the energy store. In other words, during heating operation, only as much fluid as the wall region and/or the base plate of the energy store for temperature control fluid for thermal coupling can receive is heated. Owing to this variant, the energy which is required for heating operation can be reduced particularly efficiently and particularly energy-efficient heating of the energy store can be rendered possible. Therefore, the fluid circuit can firstly selectively be used as a cooling circuit (during cooling operation) and a heating circuit (during heating operation), but, in particular during heating operation, the thermal losses are reduced owing to the thermal capacity of the fluid circuit since only the capacity of the subcircuit and/or the partial quantity of temperature control fluid heated therein is used during heating operation. The device is preferably further designed such that a direction of the fluid mass flow during cooling operation is the same as during heating operation.

As an alternative, the predetermined partial quantity of the temperature control fluid which is heated in the first step lies in the range of 80%-200%, further preferably 90%-130%, of the receiving capacity of the throughflow region. Practical tests have shown that good results can likewise be achieved with these ranges. Therefore, it is advantageous when the temperature control fluid is not heated over the entire length of the pipework of the fluid circuit, but rather only a partial quantity thereof.

In this context, the term “subcircuit” is to be understood in such a way that the fluid circuit has a subsegment in which only a partial quantity of the temperature control fluid of the fluid circuit can circulate and/or can be heated by means of the heating device. According to one embodiment, the subcircuit can have a receiving capacity for temperature control fluid which is less than 50%, further preferably less than 30% or less than 20%, of the receiving capacity of the entire fluid circuit. This has the advantage that a relatively small quantity of temperature control fluid can be heated for heating operation when the vehicle is parked, in order to thereby keep the expenditure of energy for heating as low as possible, whereas preferably the entire quantity of temperature control fluid is available during cooling operation in order to be able to reliably avoid overheating of the energy store, in particular during driving of the vehicle.

According to a further aspect, the device for controlling the temperature of the energy store can comprise an on-board electrical subsystem of the motor vehicle, which on-board electrical subsystem is supplied and/or can be supplied with electrical voltage when the ignition is switched off and/or when the battery master switch of the motor vehicle is turned off. In this way, when the vehicle is parked, it is not necessary for the entire on-board vehicle electrical system to be supplied with power, but rather only an on-board electrical subsystem which supplies electrical energy to the heating device for heating operation and optionally to further components, such as sensor devices for monitoring the predetermined heating condition, for example the energy storage temperature. Such electrical subsystem operation is particularly advantageous for trucks where it is currently common practice for truck drivers to turn off the battery master switch (of the 24 V starter battery) and therefore deactivate functions of the on-board electrical system from their vehicles when parking the vehicle overnight or over the weekend. One embodiment of the present disclosure accordingly provides that the on-board electrical subsystem in which the heating device for the energy store is arranged can still be supplied with power even when the vehicle is parked and/or the battery master switch is turned off.

In this case, supply with electrical energy can be performed by means of the energy store itself, wherein the heating device is an electrically operated heating device which is arranged in the on-board electrical subsystem. As an alternative or in addition, the energy store can also be supplied with electrical energy by means of another battery of the motor vehicle and/or by means of an external power supply if the parked vehicle is parked at a charging station, for example.

According to a further aspect, the fluid circuit can have two lines which are connected in parallel and in which the heating device and the cooling device are arranged fluidically in parallel with one another, wherein the valve device can be used to control which of the lines which are connected in parallel can be and/or is used to supply a fluid flow to the energy store. This has the advantage that the fluid flows for heating operation and for cooling operation of the device can be controlled in a correspondingly adapted manner.

For example, the device can be designed to fluidically decouple a line section having the cooling device from a line section having the energy store by means of the valve device in the above-described second step, so that heated temperature control fluid is conveyed directly to the energy store and not to the cooling device.

A predetermined heating condition is understood to mean a predefined condition or a predefined criterion which indicates or from which it is possible to derive a situation in which, in particular when the vehicle is parked, the energy store is threatening to cool down too much and correct functioning can no longer be ensured and/or would lead to excessive aging effects on the energy store. The predetermined heating condition can be satisfied, for example, if a temperature of the energy store falls below a predetermined threshold value. A suitable threshold value for the respective energy store can be determined and defined experimentally. For this purpose, the device can have a sensor device, for example at least one temperature sensor, which monitors the energy store temperature and/or the temperature of one or more storage cells of the energy store. Instead of the energy store temperature, as an alternative or in addition, another variable involved in monitoring of the heating condition can also be monitored, for example the ambient temperature and/or the temperature of the temperature control fluid of the fluid circuit. The temperature of the energy store, for example by means of a previously experimentally determined characteristic curve, can likewise be estimated from the trend of these variables.

According to a further aspect, the pump device can comprise a first pump which is arranged in the subcircuit for conveying the temperature control fluid within the subcircuit. As an alternative or in addition, the pump device can comprise a second pump which is arranged outside the subcircuit for conveying temperature control fluid to the energy store.

According to a further aspect, the device can be designed to deactivate the first pump, as described above, only after a lag time after deactivation of the heating device in order to avoid cavitation effects. Owing to lag operation of this kind, interfering cavitation effects are avoided or at least reduced during heating operation.

The device can further have a control device which is designed to drive the components of the fluid circuit, in particular the heating device, the cooling device and/or the valve device.

To the extent outlined above that the device is designed to drive one or more components of the fluid circuit for implementing heating operation, this can be performed, for example, by corresponding design of the control device. The control device can comprise one or more control units or can be implemented by programming as part of control units of this kind. Part of the functionality of the control device can also be implemented, for example, in the battery management system (BMS), for example in order to monitor the temperature of the energy store.

According to a further embodiment, a thermal insulation can be provided on or adjacent to the heating device. As a result, thermal radiation losses can be reduced and energy efficiency during heating can be improved.

The temperature control fluid can be a glycol-water mixture, in a manner known per se.

The electrical energy store can be a high-voltage battery, an electrical traction energy store and/or a lithium-ion accumulator energy store.

The present disclosure further relates to a motor vehicle comprising a device for controlling the temperature of an energy store as disclosed in this document. The motor vehicle can be an electrically driveable and/or driven motor vehicle. The motor vehicle can be a utility vehicle, such as a truck or bus for example.

According to a second general aspect of the present disclosure, a method for controlling the temperature of an energy store for electrical energy of a motor vehicle is provided, wherein the energy store can be and/or is thermally coupled to a fluid circuit for controlling the temperature of the energy store, and wherein a temperature control fluid can be supplied to and discharged from the energy store through the fluid circuit. The fluid circuit comprises a pump device for transporting the temperature control fluid through the fluid circuit, a valve device, a cooling device for cooling the temperature control fluid and a heating device for heating the temperature control fluid. The fluid circuit has a subcircuit in which the heating device is arranged.

The method comprises monitoring a predetermined heating condition when the motor vehicle is parked and activating heating operation of the heating device when a predetermined heating condition is satisfied, wherein fluidic coupling of the subcircuit to the fluid circuit and supply and discharge of temperature control fluid heated in the subcircuit to and from the energy store for electrical energy is controlled by means of the valve device.

To avoid repetition, features disclosed purely in relation to the device are also intended to count as disclosed in relation to the method and to be claimable. The abovementioned aspects and features according to the present disclosure, in particular in respect of the design of the device, the fluid circuit and the functional execution of the device, therefore also apply to the method.

The above-described preferred embodiments and features of the present disclosure can be combined with one another as desired. Further details and advantages of the present disclosure are described below with reference to the attached drawings, in which:

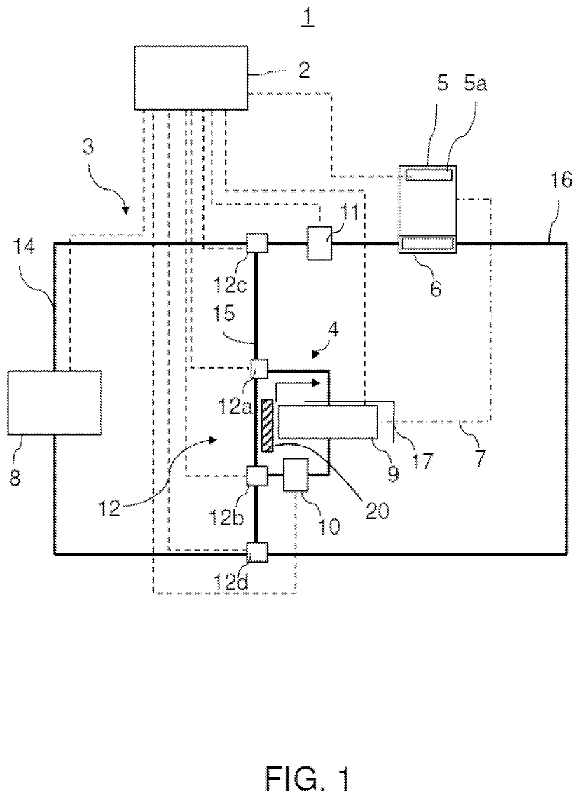

FIG. 1 shows a highly schematic view of a device for controlling the temperature of an energy store in a first step of heating operation according to one embodiment of the present disclosure;

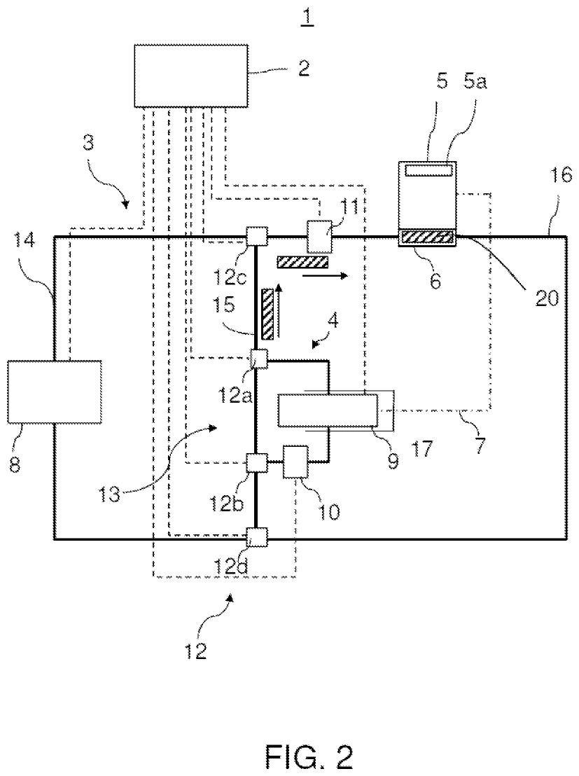

FIG. 2 shows the device from FIG. 1 in a second step of heating operation according to one embodiment of the present disclosure; and

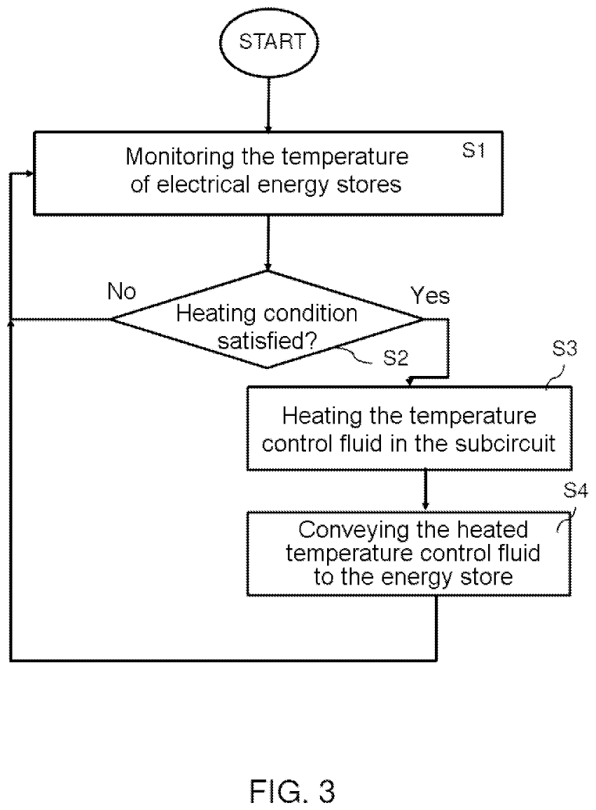

FIG. 3 shows a flowchart for illustrating the functioning of the temperature control device and a method for controlling the temperature of the energy store according to one embodiment of the present disclosure.

Identical or equivalent elements are indicated in all the figures with the same reference signs and some of them are not described separately.

FIG. 1 shows a device 1 for controlling the temperature of an energy store 5 for electrical energy of a motor vehicle according to one embodiment of the present disclosure. The motor vehicle can be an electrically driven motor vehicle, for example a truck. The energy store 5 is a high-voltage energy store and supplies electrical traction energy to an electrical machine (not illustrated) of the motor vehicle and receives recuperated energy again.

The device 1 further comprises a fluid circuit 3 which is thermally coupled to the energy store 5 for controlling the temperature of the energy store 5, wherein a temperature control fluid, for example water-glycol, can be supplied to and discharged from the energy store 5 through the fluid circuit. For this purpose, a throughflow region 6 through which the temperature control fluid can flow is provided in the base region of the energy store. In the throughflow region, the temperature control fluid can selectively flow around fins which serve as heating or cooling fins in order to achieve thermal coupling with the energy store 5.

The fluid circuit 3 comprises a pump device which, in the present case, comprises a first pump 10 and a second pump 11 for transporting the temperature control fluid through the fluid circuit 3. The fluid circuit 3 further comprises a valve device 12 which, in the present case, comprises a plurality of solenoid valves 12a to 12d.

A cooling device 8 for cooling the temperature control fluid is arranged in the line section 14. The cooling device 8 can be designed in a manner which is known per se and is therefore not described in any detail here. During cooling operation, the cooling device 8 cools the temperature control fluid flowing through it.

Here, a heating device 9 for heating the temperature control fluid is arranged in a line section 15 which is parallel to the line section 14. The heating device 9 is arranged in a fluidic subcircuit 4 in which the first pump 10 is also arranged. The heating device is at least partially encased by a thermal insulation 17, as is merely highly schematically illustrated in FIG. 1.

The device 1 further comprises a control device 2 which is connected for signaling purposes to the individual components of the fluid circuit 3 via signal lines, illustrated using dashed lines. The control device 2 is designed to drive the individual components of the fluid circuit 3. Part of the functionality of the control device 2 is also implemented in the battery management system (BMS) 5a of the energy store, wherein the battery management system is used to monitor the temperature of the energy store 5.

The heating device 9 is designed as an electrical high-voltage (HV) heater which is supplied with electrical energy from the energy store 6 by means of an on-board electrical subsystem 7, illustrated merely highly schematically by the dash-dotted line here. The special feature here is that this on-board electrical subsystem 7 is also supplied with power when the vehicle is parked and the ignition key is removed, while other parts of the on-board electrical system are deactivated. The control device 2 and the energy store 9 are supplied with electrical energy via this on-board electrical subsystem 7 even when the vehicle is parked. Furthermore, electric driving of the magnetic valve device 12 is rendered possible.

The fluid circuit 3 can be selectively used both for cooling the energy store 6 and also for heating the energy store 6 depending on whether temperature control fluid cooled by means of the cooling device 8 is conveyed to the energy store 6 or temperature control fluid heated by the heating device 9 is conveyed to the energy store 6. The circulation direction of the mass flow is the same during heating operation and cooling operation.

The energy store 6 generally has to be cooled during normal driving operation of the motor vehicle, and therefore the subcircuit 4 is normally fluidically decoupled from the rest of the fluid circuit 3 by means of the valve device 12 during driving operation. For this purpose, the valves 12c and 12d can be switched by the control device 12 such that the fluid line 14 is fluidically connected to the fluid line 16 and the fluid line 15 is not fluidically connected to the fluid lines 14 and 16. Therefore, temperature control fluid cooled by the cooling device 8 flows through a fluid circuit formed by the lines 14 and 16 into the throughflow region 6 of the energy store 5 and back to the cooling device again.

However, it has already been mentioned above that the problem of the energy store 6 cooling down too much can occur during non-driving operation when the motor vehicle is parked and given cold outside temperatures. This can have a disadvantageous effect on the service life, performance and functionality of the energy store and lead to the energy store no longer being able to provide enough power for starting operation when the vehicle is restarted.

Accordingly, the temperature control device 1 is also used, as required, for heating the energy store 5 when the motor vehicle is parked, this being explained below.

For this purpose, the control device 2 is designed to monitor whether a predetermined heating condition is satisfied when the vehicle is parked. In this case, by way of example, the temperature of the energy store 6 is monitored, wherein this temperature monitoring operation is carried out by the battery management system (BMS) 5a of the energy store 5 which also monitors the temperature of the energy store by means of temperature sensors in the energy store 5 during driving operation in any case. Here, the battery management system can access what is known as the cell module controller (CMC) in order to monitor the voltage and can access the temperature sensor installed in each cell module. This temperature monitoring with the motor vehicle parked corresponds to step S1 according to the flowchart from FIG. 3.

The battery management system measures the temperature at a specific time t. If the temperature drops below a specific limit, this is considered a situation of the heating condition being satisfied, and the control device 2 controls the subcircuit 4 and the heating device 9 for starting heating operation. This is illustrated as step S2 in FIG. 3.

In order to start heating operation, the control device 2 initially drives the valves 12a and 12b in a first step S3 such that fluid can circulate in the subcircuit 4, but cannot leave it, and activates the pump 10 and the heating device 9 in the subcircuit 4. Therefore, a small partial quantity 20 of the temperature control fluid circulates in the subcircuit 4 and in so doing is heated by the heating device 9. The subcircuit 4 is designed such that the partial quantity 20 corresponds approximately to the quantity of fluid which the energy store 6 can receive in its base plate in the throughflow region.

The temperature of the heating-up temperature control fluid is measured in the heating device 9. If the temperature control fluid in the subcircuit 4 has reached a specific temperature, the control device drives the pumps 10 and 11 and the valves 12a to 12d in a second step S4 such that the partial quantity 20 of the heated temperature control fluid 20 is conveyed from the subcircuit to the throughflow region 6 of the energy store. This process of conveying the heated partial quantity 20 of the temperature control fluid is schematically illustrated in FIG. 2 by the arrows and the moving boxes 20.

In this case, the valves 12c and 12d are switched such that the fluid lines 15 and 16 are fluidically connected to one another. In other words, in this case, the valve device 12 and the pumps 10, 11 are driven in the second step S4 in such a way that the heated partial quantity 20 of temperature control fluid is pumped into the throughflow region 9 and remains there for a minimum time period by stopping the fluid flow, in order to output the heat to the energy store 6.

In this case, several sequences of this kind for heating the energy store 9 are carried out when heating operation is activated, wherein each sequence comprises the first step (S3) and the second step (S4), so that sequential pulses of heated partial quantities 20 of the temperature control fluid are pumped to the energy store 9, instead of a continuous temperature control fluid flow.

This is repeated until the temperature of the cell modules is above a specific temperature. Heating operation is then ended and the heating device 9 is deactivated. In order to avoid cavitation effects, the pump 10 is deactivated only after a certain lag time.

Although the present disclosure has been described with reference to specific exemplary embodiments, it is evident to a person skilled in the art that various changes can be made and equivalents can be used as a substitute, without departing from the scope of the present disclosure. It should be mentioned merely by way of example that the described configuration of the fluid circuit 3 and, in particular, the valve device 12 is merely exemplary and more or fewer valves can of course be used in different embodiments and circuits. Consequently, the present disclosure is not intended to be limited to the exemplary embodiments disclosed but rather is intended to comprise all exemplary embodiments which are covered by the scope of the attached patent claims. In particular, the present disclosure also claims protection for the subject matter and the features of the dependent claims independently of the claims referred to.

### LIST OF REFERENCE SIGNS

1 Temperature control device
2 Control device
3 Fluid circuit
4 Subcircuit
5 Electrical energy store
5a Battery management system (BMS)
6 Throughflow region
7 On-board electrical subsystem
8 Cooling device
9 Heating device
10 First pump
11 Second pump
12 Valve device
12a, 12b, 12c, 12d Valves
14 Fluid line
15 Fluid line
16 Fluid line
17 Thermal insulation
20 Partial quantity of the temperature control fluid

1. A device (1) for controlling the temperature of an energy store (5) for electrical energy of a motor vehicle, comprising
an energy store (5) for electrical energy, preferably a high-voltage battery;
a fluid circuit (3) which can be and/or is thermally coupled to the energy store (5) for controlling the temperature of the energy store (5), wherein a temperature control fluid can be supplied to and discharged from the energy store (5) through the fluid circuit;
wherein the fluid circuit (3) comprises a pump device (10, 11) for transporting the temperature control fluid through the fluid circuit (3), a valve device (12), a cooling device (8) for cooling the temperature control fluid and a heating device (9) for heating the temperature control fluid, wherein the fluid circuit (3) has a subcircuit (4) in which the heating device (9) is arranged;
wherein the device (1) is designed to activate heating operation of the heating device (9) when the motor vehicle is parked and when a predetermined heating condition is satisfied, wherein fluidic coupling of the subcircuit to the fluid circuit and supply and discharge of temperature control fluid heated in the subcircuit to and from the energy store (5) for electrical energy can be controlled by means of the valve device (12).

2. The device (1) as claimed in claim 1, wherein the device (1), when heating operation is activated, is designed
a) to heat a predetermined partial quantity (20) of the temperature control fluid in the subcircuit (4) using the heating device (9) in a first step (S3), wherein the subcircuit (4) is fluidically separated from the rest of the fluid circuit (3) and/or the energy store (5) by means of the valve device (12); and
b) to fluidically connect the subcircuit (4) to the energy store (5) by means of the valve device (12) and to pump the heated predetermined partial quantity (20) to the energy store by means of the pump device (10, 11) in a second step (S4).

3. The device (1) as claimed in claim 2, wherein the device is designed to carry out several sequences for heating the energy store (9) when heating operation is activated, wherein each sequence comprises the first step (S3) and the second step (S4), preferably in such a way that sequential pulses of heated partial quantities (20) of the temperature control fluid are pumped to the energy store (9), instead of a continuous temperature control fluid flow.

4. The device (1) as claimed in claim 2 or 3, wherein the energy store (5) is thermally coupled to the fluid circuit (3) via a throughflow region (6) formed in a wall region, preferably in a base plate, of the energy store (5), wherein the predetermined partial quantity (20) of the temperature control fluid which is heated in the first step
a) corresponds to a receiving capacity of the throughflow region (6) of the energy store, or
b) lies in the range of 80%-200%, further preferably 90%-130%, of the receiving capacity of the throughflow region (6).

5. The device (1) as claimed in one of claims 2 to 4, wherein the device is designed to drive the valve device (12) and the pump device (10, 11) in the second step (S4) in such a way that the heated predetermined partial quantity (20) is pumped into the throughflow region (9) and remains there for a minimum time period by stopping the fluid flow.

6. The device as claimed in one of the preceding claims, wherein the subcircuit (4) has a receiving capacity for temperature control fluid which is less than 50%, further preferably less than 30% or less than 20%, of the receiving capacity of the fluid circuit (3).

7. The device (1) as claimed in one of the preceding claims, comprising an on-board electrical subsystem (7) of the motor vehicle, which on-board electrical subsystem is supplied and/or can be supplied with electrical voltage when the ignition is switched off and/or when the battery master switch of the motor vehicle is turned off, preferably via the energy store (6), wherein the heating device (9) is an electrically operated heating device which is arranged in the on-board electrical subsystem (7).

8. The device (1) as claimed in one of the preceding claims, wherein the fluid circuit (3) has two lines (14, 15) which are connected in parallel and in which the heating device (9) and the cooling device (8) are arranged fluidically in parallel with one another, wherein the valve device (12) can be used to control which of the lines (14, 15) which are connected in parallel can be and/or is used to supply a fluid flow to the energy store (9).

9. The device (1) as claimed in claims 2 and 8, wherein the device (1) is designed to fluidically decouple a line section (14) having the cooling device (8) from a line section (16) having the energy store (6) by means of the valve device (12) in the second step (S4).

10. The device (1) as claimed in one of the preceding claims, wherein the predetermined heating condition is satisfied if a temperature of the energy store falls below a predetermined threshold value.

11. The device (1) as claimed in one of the preceding claims, wherein the pump device (10,

11. comprises a first pump (10) which is arranged in the subcircuit for conveying the temperature control fluid within the subcircuit (4) and/or a second pump (11) which is arranged outside the subcircuit for conveying temperature control fluid to the energy store (⁹).

12. The device (1) as claimed in claim 11, wherein the device is designed to deactivate the first pump (10) only after a lag time after deactivation of the heating device in order to avoid cavitation effects.

13. The device (1) as claimed in one of the preceding claims,
a) wherein a thermal insulation (17) is provided on or adjacent to the heating device; and/or
b) wherein the temperature control fluid is a glycol-water mixture; and/or
c) wherein the energy store (5) is a lithium-ion accumulator energy store and/or a high-voltage energy store.

14. A motor vehicle, preferably utility vehicle, such as a truck or bus for example, comprising a device (1) as claimed in one of the preceding claims.

15. A method for controlling the temperature of an energy store (5) for electrical energy of a motor vehicle, wherein the energy store (5) can be and/or is thermally coupled to a fluid circuit (3) for controlling the temperature of the energy store (5), wherein a temperature control fluid can be supplied to and discharged from the energy store (5) through the fluid circuit, and wherein the fluid circuit (3) comprises a pump device (10, 11) for transporting the temperature control fluid through the fluid circuit (3), a valve device (12), a cooling device (8) for cooling the temperature control fluid and a heating device (9) for heating the temperature control fluid, wherein the fluid circuit (3) has a subcircuit (4) in which the heating device (9) is arranged;
wherein the method comprises:
a) monitoring a predetermined heating condition when the motor vehicle is parked; and
b) activating heating operation of the heating device (9) when a predetermined heating condition is satisfied, wherein fluidic coupling of the subcircuit to the fluid circuit and supply and discharge of temperature control fluid heated in the subcircuit to and from the energy store (5) for electrical energy is controlled by means of the valve device (12).
